(19) United States
(12) Patent Application Publication
(10) Pub. No.: US 2020/0139949 A1
(43) Pub. Date: May 7, 2020

(54) BRAKING SYSTEM

(71) Applicant: Continental Teves AG & Co. OHG, Frankfurt (DE)

(72) Inventors: Joseph Dolmaya, Oberursel (DE); Rüdiger Briesewitz, Bruchköbel (DE); Dieter Dinkel, Schwalbach (DE)

(73) Assignee: Continental Teves AG & Co. OHG, Frankfurt (DE)

(21) Appl. No.: 16/737,297

(22) Filed: Jan. 8, 2020

Related U.S. Application Data
(63) Continuation of application No. PCT/EP2018/068543, filed on Jul. 9, 2018.

(30) Foreign Application Priority Data
Jul. 12, 2017 (DE) 10 2017 211 953.5

(51) Int. Cl. B60T 8/40; B60T 11/10; B60T 7/04; B60T 13/68

(52) U.S. Cl. CPC B60T 8/4081; B60T 11/103; B60T 11/22; B60T 13/686; B60T 7/042

(57) ABSTRACT

Braking system for motor vehicles, with a primary brake control unit comprising at least one electrically actuable wheel valve for each wheel brake, for the purposes of setting wheel-specific brake pressures; a pressure medium storage tank which is at atmospheric pressure; and an electrically controllable pressure provision device for actuating the wheel brakes with a hydraulic pressure chamber, wherein the respective wheel brake is connected or can be connected hydraulically to the pressure chamber; wherein the braking system comprises a simulation unit with a simulator which can be actuated with the aid of a brake pedal, and an auxiliary module, wherein the auxiliary module comprises a hydraulic unit with an, in particular, electrically controllable, pressure provision device for active pressure build-up in at least two of the wheel brakes, and wherein the simulation unit is designed as a separate module.

### CROSS REFERENCE TO RELATED APPLICATIONS

This application is the U.S. national phase application of PCT International Application No. PCT/EP2018/068543, filed Jul. 9, 2018, which claims priority to German Patent Application No. DE 10 2017 211 953.5, filed Jul. 12, 2017, wherein the contents of such applications are incorporated herein by reference.

### TECHNICAL FIELD

A braking system for motor vehicles.

### TECHNICAL BACKGROUND

In motor vehicle engineering, “brake-by-wire” braking installations are being used ever more widely. Braking installations of this kind often have not only a brake master cylinder that can be actuated by the vehicle driver but also an electrically activatable pressure provision device, by means of which actuation of the wheel brakes takes place in the “brake-by-wire” operating mode. The brake master cylinder, which, for a hydraulic fallback level, is connected to the wheel brakes, is decoupled from the wheel brakes in the “brake-by-wire” operating mode and connected to a simulator, which imparts to the driver a brake pedal feel which is as familiar and comfortable as possible in the “brake-by-wire” operating mode. In the “brake-by-wire” operating mode, the actual braking is thus achieved by active pressure build-up in the brake circuits by means of the pressure provision device, which is activated by a control and regulating unit. By virtue of the brake pedal actuation being hydraulically decoupled from the pressure build-up (in the “brake-by-wire” operating mode), a large number of functionalities, such as ABS, ESC, TCS, slope launch assistance etc., can be implemented in a convenient manner for the driver in braking systems of this kind. The disadvantage with braking systems of this kind, in which the brake master cylinder, the simulator and the pressure provision device are arranged in one module, is that vibration due to the pressure provision device or due to the actuation of the simulator is transmitted directly to the bulkhead. The frequencies which arise in this context may also be reinforced by resonance. Depending on the design of the car, this can lead to significant NVH (noise, vibration, harshness) disadvantages. Moreover, brake-by-wire braking installations of this kind are not suitable for use in the case of automated driving.

DE 10 2013 223 859 A1 discloses a “brake-by-wire” braking installation for motor vehicles, which has a simulator that can be actuated by a brake pedal and has an electrically controllable pressure provision device, which is formed by a cylinder-piston arrangement having a hydraulic pressure chamber, the piston of which can be moved by an electromechanical actuator. Such a brake-by-wire braking system is not suitable for use in automated driving, in the case of which the vehicle control is partially or substantially entirely automated, such that the driver can perform other activities. If there is a failure in the normal level of the braking system, there must always remain a possibility of braking the vehicle.

What is needed is an improved braking system in such a way that it is suitable for highly automated driving and, at the same time, can be mounted in the motor vehicle in a manner which is convenient and flexible for the driver, and to greatly reduce the NVH disadvantages.

### BRIEF DESCRIPTION OF THE DRAWINGS

An exemplary embodiment of the invention will be discussed in more detail on the basis of a drawing. In the drawing, in a highly schematic illustration:

FIG. 1 shows a braking system having an auxiliary module and a simulation module in an exemplary embodiment;

FIG. 2 shows the braking system according to FIG. 1 in an operating state during a normal braking process;

FIG. 3 shows the braking system according to FIG. 1 in an operating state during an ABS control process;

FIG. 4 shows the braking system according to FIG. 1 in another operating state during an ABS control process;

FIG. 5 shows the braking system according to FIG. 1 in another operating state during an ABS control process;

FIG. 6 shows the braking system according to FIG. 1 in another operating state during an ABS control process;

FIG. 7 shows the braking system according to FIG. 1 in an operating state during an ESC control process; and

FIG. 8 shows the braking system according to FIG. 1 in an operating state during an ESC control process.

In all of the figures, identical parts are denoted by the same reference designations.

### DETAILED DESCRIPTION

In one or more embodiments, a simulation unit is designed as a separate module, and a (further) auxiliary module is provided, which comprises a second pressure provision device for active pressure build-up at at least some of the wheel brakes.

Stresses due to noise, vibration, and/or harshness (NVH) arise, inter alia, from control operations, valve switching processes etc., which are transmitted to the bulkhead. However, it would be desirable to reduce these disturbances which occur in known braking systems mounted on the bulkhead. As has now been recognized, these disadvantages can be eliminated by designing the simulation module structurally as an independent component or independent module. The operation of the simulation module causes the disturbances mentioned to a lesser extent and it can therefore be secured on the bulkhead. Both the primary brake control unit and the auxiliary module, which can ensure a basic braking functionality including take over by the driver if the primary brake control unit fails, can be arranged at other points in the vehicle at which they do not lead to increased NVH noise.

The simulation unit is designed as a module separate from the primary brake control unit. The simulation unit is optionally also designed as a module separate from the auxiliary module.

The simulation unit is optionally not connected to any of the wheel brakes in the sense of the possibility of a build-up of brake pressure at the wheel brakes. In other words, there is optionally no mechanical and/or hydraulic operative connection provided between the brake pedal and the wheel brakes.

The design of the simulation unit as a separate module optionally means that the module is designed as a structural unit which can be mounted in the vehicle, in particular on the bulkhead, independently of the other components of the braking system. A connection with the primary brake control unit optionally exists only via a hydraulic connection of the respective pressure medium storage tank or via signal lines (cables or by radio) between a control and regulating unit of the simulation unit and control and regulating units of the primary brake control unit and/or of the additional module.

It is advantageous if the simulation unit has a hydraulic pressure chamber, which is connected hydraulically to a simulator unit pressure medium storage tank.

The simulator unit pressure medium storage tank is optionally connected hydraulically to the pressure medium storage tank of the primary brake control unit.

The simulation unit optionally has a control and regulating unit, in particular for driver demand detection.

It is advantageous if a pressure sensor for determining the pressure in the pressure chamber and a travel sensor for determining the actuating travel of the brake pedal are provided in the simulation unit, wherein the control and regulating unit of the simulation unit is connected on the signal input side to both sensors.

The braking system optionally has a first onboard electrical system and a second onboard electrical system, wherein the primary brake control unit is supplied with electric power by the first onboard electrical system, the auxiliary module is supplied with electric power by the second onboard electrical system, and the simulation unit is or can be supplied with electric power by the first and the second onboard electrical system. In this way, driver demands can be detected reliably at any time.

It is advantageous if the primary brake control unit and the auxiliary module are designed as structurally separate components. This enables them to be arranged separately in the motor vehicle.

The primary brake control unit and/or the auxiliary module optionally have/has fastening means for mutual fastening and/or for fastening on the simulation unit.

It is advantageous if the braking system is designed fully for by-wire operation, and therefore no brake master cylinder that can be actuated with the aid of the brake pedal is provided. The brake pedal is part of the simulator unit and actuates exclusively the simulator.

At least one check valve is optionally inserted into a hydraulic connection between the pressure chamber and the wheel brakes, which check valve prevents a return flow of brake fluid from the direction of the wheel brakes into the pressure chamber and allows an inflow of brake fluid from the pressure chamber in the direction of the wheel brakes. By virtue of the design of the braking system, check valves are sufficient in this context. Pressure activation valves are not required.

Each wheel brake is optionally assigned an inlet valve, which is open when deenergized.

Each wheel brake is optionally assigned an outlet valve, which is closed when deenergized.

It is advantageous if a pressure sensor is provided for measuring the pressure in the pressure chamber of the first pressure provision device.

It is advantageous if at least one reservoir for brake fluid is integrated into the hydraulic unit in the auxiliary module. This enables the auxiliary module to build up wheel brake pressure quickly and independently of an external pressure medium supply, e.g. from the storage tank.

The respective reservoir is optionally connected to a hydraulic equalization line which is provided for forming a connection to the atmosphere.

The pressure provision device of the auxiliary module advantageously comprises at least one pump which is driven by means of an electric motor and the suction side of which is hydraulically connected to the respective reservoir.

The auxiliary module is optionally connected hydraulically between the primary brake control unit, in particular at least some of the wheel-specific output pressure ports of the primary brake control unit, and the at least two wheel brakes.

The advantages are in that the simulator unit can be of space-saving construction and can be mounted directly on the bulkhead, while the primary brake control unit and the auxiliary module can be mounted at other points. As a result, the controller and pressure setting units cannot transmit any frequencies directly to the bulkhead. By virtue of the division of the simulator module, the braking system can be designed fully for brake-by-wire operation, thus making it possible to dispense with a tandem brake master cylinder. Fewer valves and hence also fewer coils in the control and regulating unit are required in the primary brake control unit. Through the saving of components, the primary brake control unit can be of compact construction.

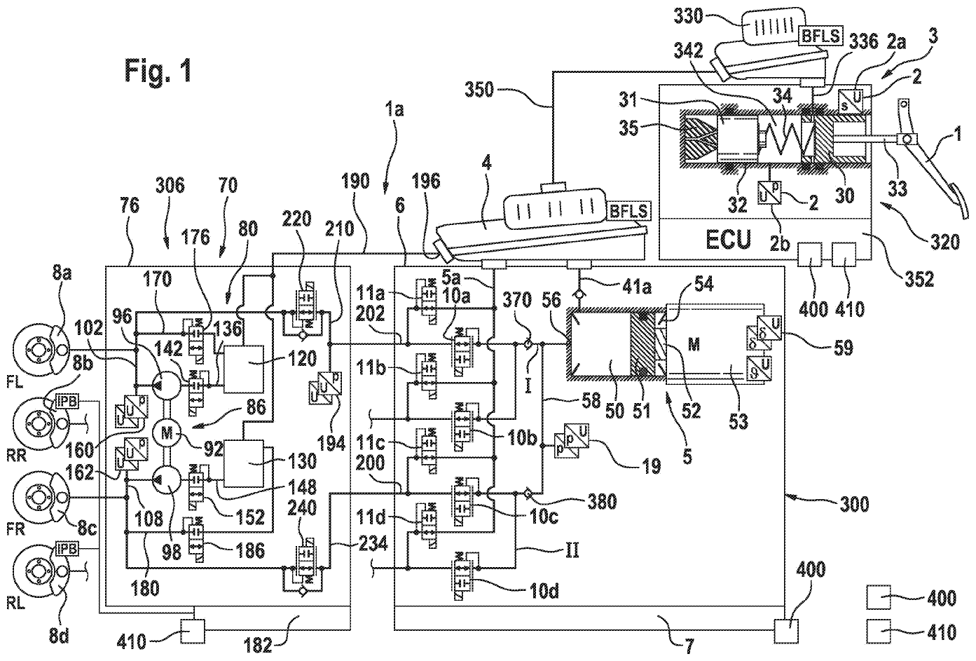

FIG. 1 illustrates a braking system 1a schematically in one or more embodiments. The braking installation comprises a brake actuating element, in the present case a brake pedal 1, a simulation device 3, which is coupled to the brake actuating element 1 and has a measuring device 2, optionally of redundant design, for detecting a brake actuation by the vehicle driver, which in the example under consideration comprises a travel sensor 2a for detecting an actuating travel and a pressure sensor 2b, an electronic control and regulating unit 7, a pressure medium storage tank 4 under atmospheric pressure, and an electrically controllable pressure modulation device 6 (hydraulic unit, HCU), to which hydraulically actuable wheel brakes 8a-8d of a motor vehicle (not illustrated) can be connected. The pressure modulation device 6 comprises an electrically controllable pressure source 5, a plurality of electrically actuable valves 10a-d, 11a-d, and at least one pressure sensor 19, optionally of redundant design, for detecting a pressure of the pressure source 5.

In this arrangement, each wheel brake 8a-8d is assigned an inlet valve 10ad, which is open when deenergized, and an outlet valve 11a-d, which is closed when deenergized, which are connected to a common discharge line 5a. The braking installation or braking system 1a does not comprise a brake master cylinder which can be actuated by means of the brake actuating element 1 and is connected or can be connected to the wheel brakes 8a-8d. This is a “brake-by-wire” braking installation, in which the vehicle driver has no possibility of direct mechanical/hydraulic actuation of the wheel brakes. There is therefore no mechanical or hydraulic fallback level involving direct intervention by the vehicle driver on the wheel brakes. A braking demand by the vehicle driver is transmitted or implemented exclusively by electric means (“by-wire”).

According to the exemplary embodiment, the wheel brakes 8a and 8b are assigned to the left-hand front wheel (FL) and right-hand rear wheel (RR) and connected to a first brake circuit supply line I. The wheel brakes 8c and 8d are assigned to the right-hand front wheel (FR) and the left-hand rear wheel (RL) and are connected or can be connected to the second brake circuit supply line II (“diagonal split”).

The simulation device 3 advantageously gives the vehicle driver a familiar brake pedal feel when the brake pedal 1 is actuated. The simulation device 3 optionally comprises a simulator having two pistons 30, 31, which are arranged in series and which are guided movably in a housing 32. A piston rod 33 couples the pivoting movement of the brake pedal 1 resulting from a pedal actuation to the translational movement of the first piston 30, the actuation travel of which is detected by a travel sensor 2a. The piston 30 is supported on the piston 31 via a spring 34. The piston 31 is supported on the housing 32 via an elastic element 35.

The electrically controllable pressure source 5 comprises a hydraulic cylinder-piston arrangement, the piston 51 of which can be actuated by an electromechanical actuator, which, according to the example, is formed by a schematically indicated electric motor 53 and a likewise schematically illustrated rotation-translation mechanism 52. The rotation-translation mechanism 52 is optionally formed by a ball screw drive. The pressure source 5 is optionally formed by a bore, which is arranged in the housing of the pressure modulation device 6 and in which the piston 51 is movably guided.

Together with the housing, the piston 51 delimits a pressure chamber 50. The pressure source 5 is of single-circuit design, i.e. the pressure source 5 or the pressure chamber 50 thereof is connected or can be connected to all the hydraulically actuable wheel brakes 8a-8d of the motor vehicle. By moving the piston 51 in the actuating direction (to the left in FIG. 1), pressure medium can be displaced out of the pressure chamber 50 to the wheel brakes 8a-8d. A port 56 of the pressure source 5 for the wheel brakes 8a-8d is connected to a system pressure line section 58, which is connected to the brake circuit supply lines I, II. The pressure chamber 50 is connected to the pressure medium storage tank 4 by a pressure equalization line 41a, into which a check valve (not designated specifically) is inserted. Via the line 41a, additional pressure medium can be drawn into the pressure chamber 50 by a backward movement of the piston 51. According to the example, the pressure sensor 19 for detecting the pressure of the pressure source 5 is arranged in the region of the system pressure line section 58.

Irrespective of the state of actuation of the piston 51, that is to say, for example, also in the unactuated state of the piston 51, the pressure chamber 50 is sealed against atmospheric pressure by means of a first sealing element 54, which, according to the example, is arranged on the piston 51 (as illustrated in FIG. 1).

To detect a variable characteristic of the position/location of the piston 51 of the pressure source 5, there is a sensor 59, which, according to the example, is embodied as a rotor position sensor used to detect the rotor position of the electric motor 53. Other sensors are likewise conceivable, e.g. a travel sensor for detecting the position/location of the piston 51. By means of the variable characteristic of the position/location of the piston 51, it is possible to determine the pressure medium volume output or received by the pressure source 5.

According to the example, the pressure modulation device 6 is provided, for each wheel brake 8a, 8b of the first brake circuit I, with an electrically actuable, inlet valve 10a, 10b, which is open when deenergized and is arranged between the wheel brake 8a, 8b and the brake circuit supply line I (i.e. between the pressure source 5 and the wheel brake 8a, 8b), and an electrically actuable, optionally analogized or analog-controlled outlet valve 11a, 11b, which is open when deenergized and is arranged between the wheel brake 8a, 8b and the pressure equalization line 5a. For each wheel brake 8c, 8d of the second brake circuit II, an electrically actuable inlet valve 10c, 10d, which is closed when deenergized and is arranged between the pressure source 5 and the wheel brake 8c, 8d, and an electrically actuable, optionally analogized or analog-controlled outlet valve 11c, 11d, which is open when deenergized and is arranged between the wheel brake 8c, 8d and the pressure equalization line 5a, are provided. In the deenergized state of the braking installation, the wheel brakes 8a, 8b are connected to the pressure medium storage tank 4 via the open valves 10a, 10b, and the wheel brakes 8c, 8d are connected to said tank via the open valves 10c, 10d.

The electronic control and regulating unit (ECU) 7 is used, for example, to control the pressure source 5 and the valves 10a-d, 11a-d of the pressure modulation device 6 and to evaluate the signals from the sensors of the pressure modulation device 6. In the control and regulating unit 7 or in a further control and regulating unit, a vehicle deceleration setpoint, e.g. a setpoint system pressure for the pressure source, is determined from the detected driver braking demand.

The braking system 1a furthermore has an auxiliary module 70, which can perform braking actions in the event of failure of the pressure build-up capability of the braking installation 1. In this way, the time period until the driver can take over the braking of the vehicle can be bridged.

The auxiliary module 70 has a hydraulics unit 80 arranged in a housing or hydraulic housing 76. A pressure provision device 86 comprises an electric motor 92 by means of which, if required, two pumps 96, 98 are operated. The pump 96 is connected at the pressure side via a hydraulic line or wheel brake feed line 102 to the wheel brake 8a. The pump 98 is connected at the pressure side via a line or wheel brake feed line 108 to the wheel brake 8c.

In this way, pressure can be built up actively in the front wheel brakes 8a, 8c with the aid of the auxiliary module. The auxiliary module 70 is designed to be able to reliably take over a braking function when required. For this purpose, two reservoirs 120, 130 for brake fluid are provided, which are integrated in the hydraulic unit 80 and which are arranged in the hydraulic housing 76. The brake fluid reservoir 120 is hydraulically connected to the suction side of the pump 96 via a hydraulic line 136, into which there is connected a reservoir valve 142, which is closed when deenergized. The reservoir 130 is hydraulically connected, at the suction side, to the pump 98 via a hydraulic line 148, into which there is connected a reservoir valve 152, which is closed when deenergized.

A pressure sensor 160 which is optionally of redundant design measures the pressure in the line 102. A pressure sensor 162 of optionally redundant design measures the pressure in the line 108. A control and regulating unit 182 is connected at the signal input side to the pressure sensors 160, 162.

From the line 102, there branches off a hydraulic return line 170 which hydraulically connects line 102 to the reservoir 120, wherein a return valve 176, which is closed when deenergized, is connected into the return line. From the line 108, there branches off a hydraulic return line 180, into which a return valve 186, which is closed when deenergized, is connected.

Below, the hydraulic connection of the auxiliary module 70 to the braking installation 1 will be described. A common hydraulic equalization line 190 connects the two reservoirs 120, 130 to the brake medium reservoir tank 4 at a brake medium reservoir tank port 196.

The wheel brake 8a, which in the present case corresponds to the left-hand front-wheel brake, is connected to the pressure provision device 5 via a brake line 202. The wheel brake 8c, which corresponds to the right-hand front-wheel brake, is connected by means of a brake line 200 to the pressure provision device 5.

The auxiliary module 70 is connected hydraulically into the brake lines 200, 202 such that a respective section of said brake lines runs in the auxiliary module 70. In this way, the auxiliary module can build up brake pressure in the brakes 8a, 8c as required. The brake line 200 runs, in a line section 210, within the auxiliary module 70. An isolating valve 220, which is open when deenergized, is inserted in line section 210. A pressure sensor 194 measures the pressure in the brake line 200. The signal of the pressure sensor 194 serves optionally for detecting the driver braking demand in a fall-back level, in which the brake pressure setting is performed by the auxiliary module 70.

The brake line 202 runs, in a line section 234, within the auxiliary module 70. An isolating valve 240, which is open when deenergized, is inserted in line section 234. The auxiliary module 70 is designed to build up pressure actively, when required, in the front wheel brakes 8a, 8c. There is no check valve connected in parallel with either of the isolating valves 220, 240.

The braking system 1a allows 100% brake-by-wire actuation. The braking system 1a is formed from two or three assemblies or modules, which can also be connected to one another by means of fastening devices. The 3 assemblies can be seen in the circuit diagram of the braking system 1d. A first module 300 comprises the ECU 7, the pressure provision device 5, the pressure medium storage tank 4 and the valves 10a-d, 11a-d. It forms the primary brake control unit, with the aid of which brake pressure can be built up actively in all four wheel brakes 8a-8d in normal operation. A second module 306 is the auxiliary module 70, which can still build up brake pressure actively at the front axle if the module 300 fails.

Modules 300 and 306 optionally have fastening devices, by means of which they can be mounted on one another or at a desired position in the vehicle.

For reasons of NVH, the positioning of the modules 300 and 306 away from the bulkhead is advantageous. Thus, vibrations which are generated by the motors and/or pumps are not transferred to the bulkhead. As an alternative, it is also possible for modules 300, 306 to be of mutually integrated design.

A third module 320 comprises the simulator unit or simulation unit 3. The simulation device 3 comprises a simulator pressure medium storage tank 330, which is connected hydraulically via a suction line 336 to a hydraulic pressure chamber 342, into which the piston 30 is moved when the brake pedal 1 is actuated. The simulator pressure medium storage tank 330 is furthermore connected to the pressure medium storage tank of the module 300 via an equalization line 350. The simulation device 3 has a control and regulating unit 352, which performs driver demand detection, in particular with the aid of the signals of the sensors 2a, 2b. The module 320 is designed structurally as a separate component in such a way that it can be mounted directly on the bulkhead of the motor vehicle, wherein the other two modules 300, 306 can be mounted at different points, in particular not directly on the bulkhead. In this way, NVH disturbances can be avoided since noises generated by actuator actuations or valve actuations are not transmitted to the bulkhead.

The driver actuates the simulator unit or simulation unit 3 directly via the brake pedal 1 and the coupling rod 33 or piston rod and in this way introduces the force exerted by the driver directly into the simulator. Since only the simulator unit is mounted on the bulkhead, neither motor vibrations nor valve actuations are transmitted to the bulkhead. The simulator unit 3 is furthermore of very small design in comparison with known brake-by-wire braking installations and requires very little installation space since only the simulator components are situated in this block. As an option, the brake reservoir or simulator pressure medium storage tank 330 can be used as the main tank for all the assemblies or merely as an extra tank for the simulation unit 3.

The pressure setting and control unit of the module 300 unit can be positioned in any desired manner in the car by virtue of the fact that the HMI (human machine interface) is no longer required here. Accordingly, the vibrations, valve actuation switchover operations and general NVH phenomena are no longer transferred directly to the bulkhead. Since the simulator is arranged in the simulator unit, the in module 300 is no longer required. Moreover, a diagnostic valve is eliminated, said valve being used in known braking installations to enable leaks within the tandem brake master cylinder to be measured. No tandem brake master cylinder is required for the braking system 1a illustrated here. The isolating valves of the tandem brake master cylinder are accordingly also eliminated since there is no hydraulic pressure connection between the simulator unit and the module 300.

No pressure activation valves are required in the braking system 1a. Instead, a respective check valve 370, 380 is in each case inserted between inlet valves 10a, 10b and pressure chamber 50 and between inlet valves 10c, 10d and the pressure chamber, each of said check valves preventing pressure medium from flowing back into the pressure chamber 50 and allowing it to flow to the wheel brakes 8a-d.

If a pressure is to be built up within a brake circuit or in wheel brakes, the corresponding inlet valves 10a-d, which are open when deenergized, are switched over.

The braking system 1a has two onboard electrical systems, a first onboard electrical system 400 and a second onboard electrical system 410. The first onboard electrical system 400 is attached to module 300. The second onboard electrical system 410 is attached to the auxiliary module 70. To ensure that the driver demand is reliably detected at all times and can be transmitted to the corresponding ECU 182, 7, both onboard electrical systems 400, 410 are attached to the ECU 352 of module 320.

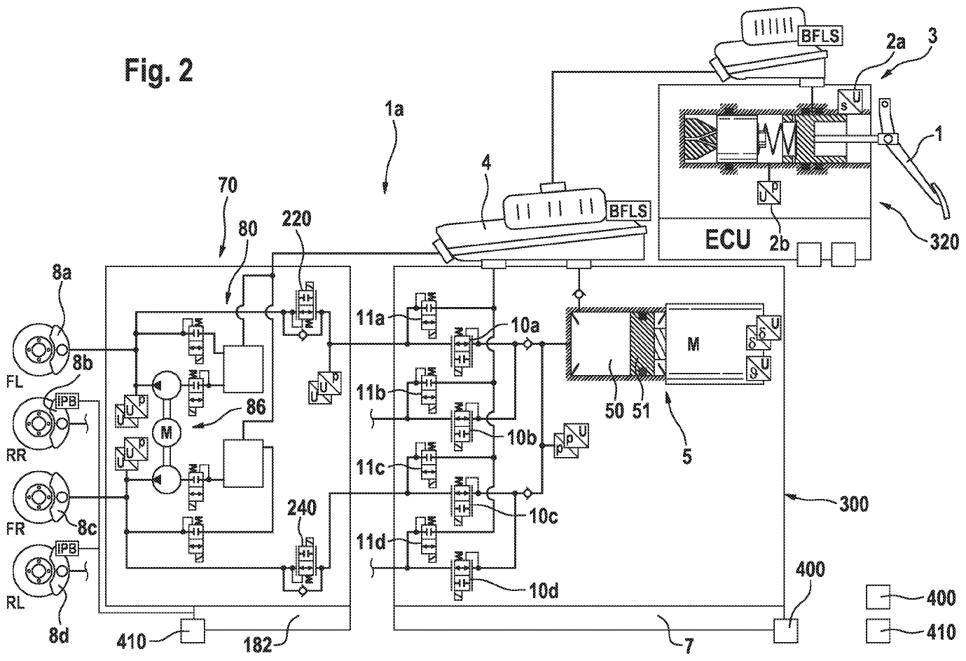

FIGS. 2-8 show the braking system of FIG. 1 in various switching states. In these figures, just some of the reference signs are entered for the sake of greater clarity.

In FIG. 2, the braking system 1a is illustrated during a normal braking process. The inlet valves 10a-10d are all open, and therefore pressure medium can flow out of the pressure chamber 50 into the wheel brakes 8a-8d. Owing to a detected driver braking demand, the piston 51 is moved into the pressure chamber 50 to build up brake pressure. The outlet valves 11a-11d are all switched to their closed position. The isolating valves 220, 240 are in their open position.

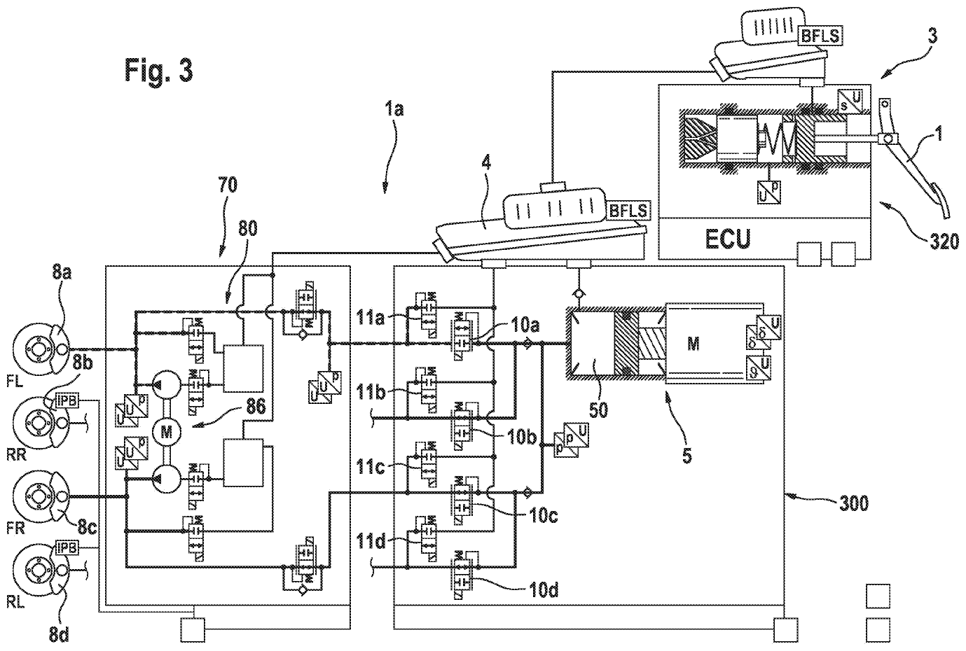

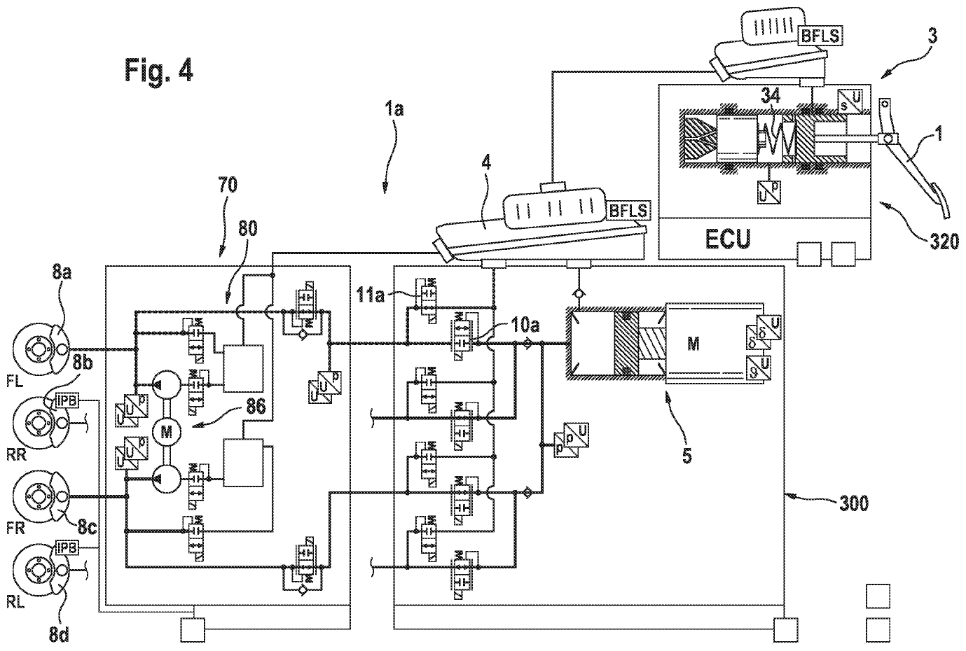

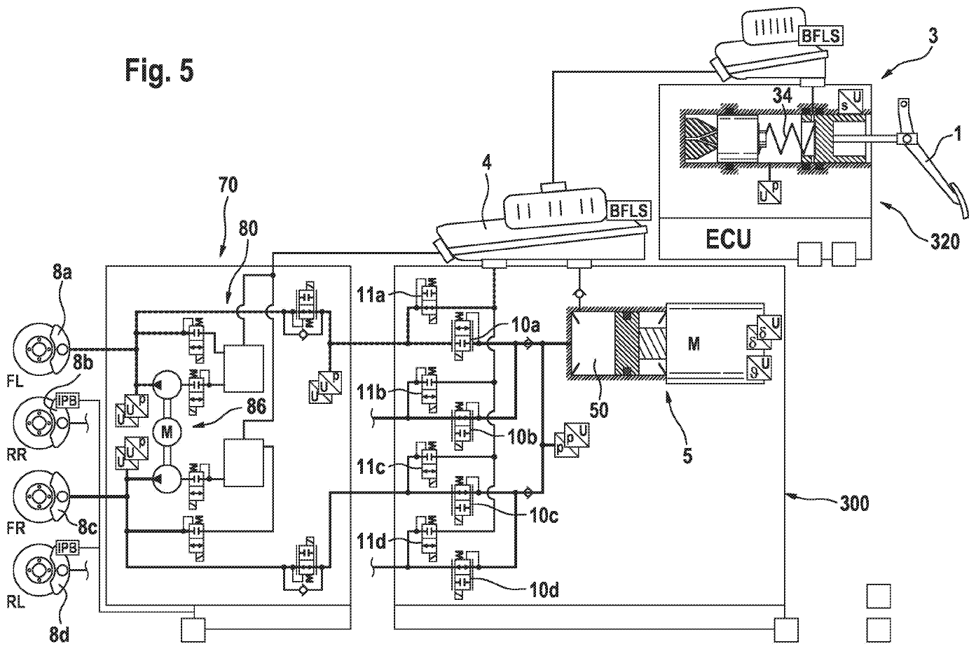

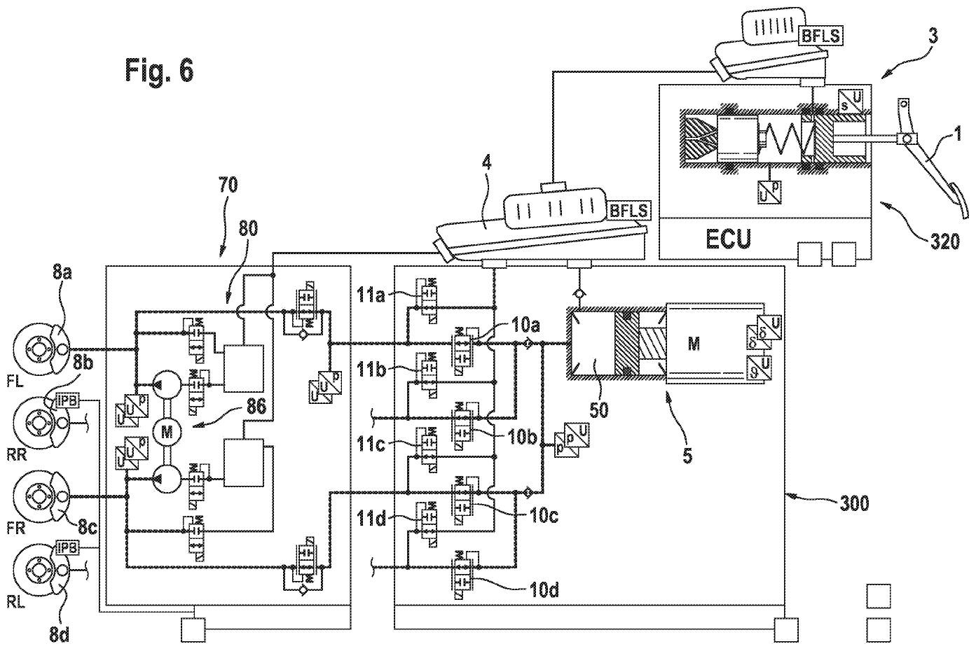

In FIG. 3, the braking system 1a is illustrated during an ABS control process. The inlet valve 10a is closed and the inlet valves 10b-10d are open. The outlet valves 11a-11d are closed. The wheel brake 8a is thereby separated hydraulically from the pressure chamber 50. During the ABS control process, as shown in FIG. 4, the outlet valve 11a is then opened. In this way, brake fluid can flow out of the wheel brake 8a into the pressure medium storage tank 4, with the result that the wheel brake pressure in the wheel brake 8a decreases. The driver actuates the brake pedal 1, and the spring element 34 is compressed. In FIG. 5, the driver has released the brake pedal 1 again. In FIG. 6, all the outlet valves 11a-11d are open, thus enabling wheel brake pressure to be reduced in all the wheel brakes 8a-8d.

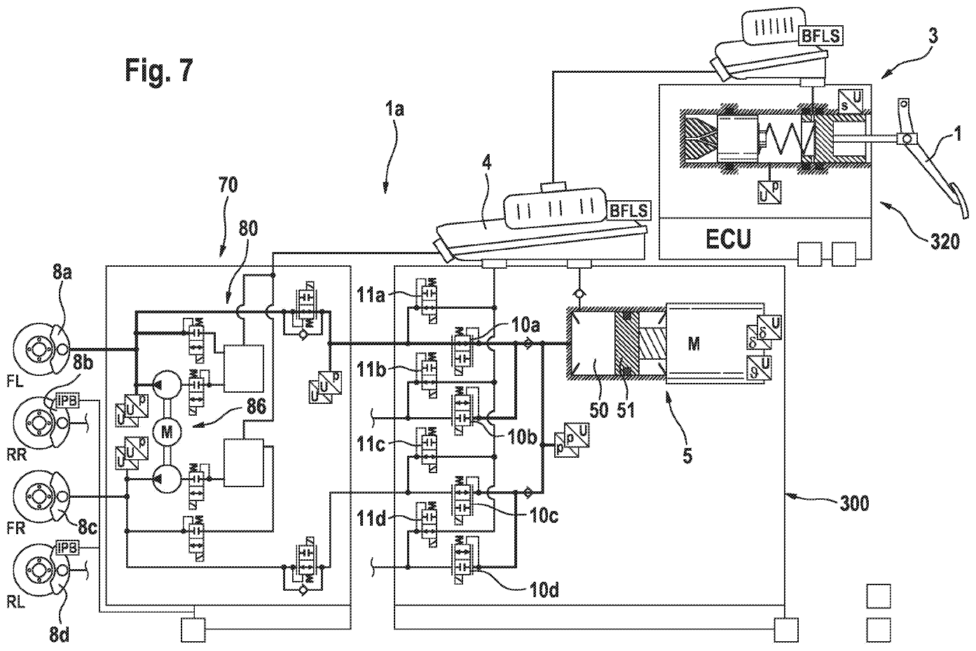

In FIG. 7, the braking system 1a is illustrated during an ESC control process. Inlet valves 10b-10d are closed, and inlet valve 10a is open. All the outlet valves 11a-11d are closed. As a result, only wheel brake 8a is connected to the pressure chamber 50. In this way, wheel brake pressure can be selectively built up only in wheel brake 8a when the piston 51 is moved into the pressure chamber 50, while the previously set wheel brake pressure in wheel brakes 8b-8d remains unchanged.

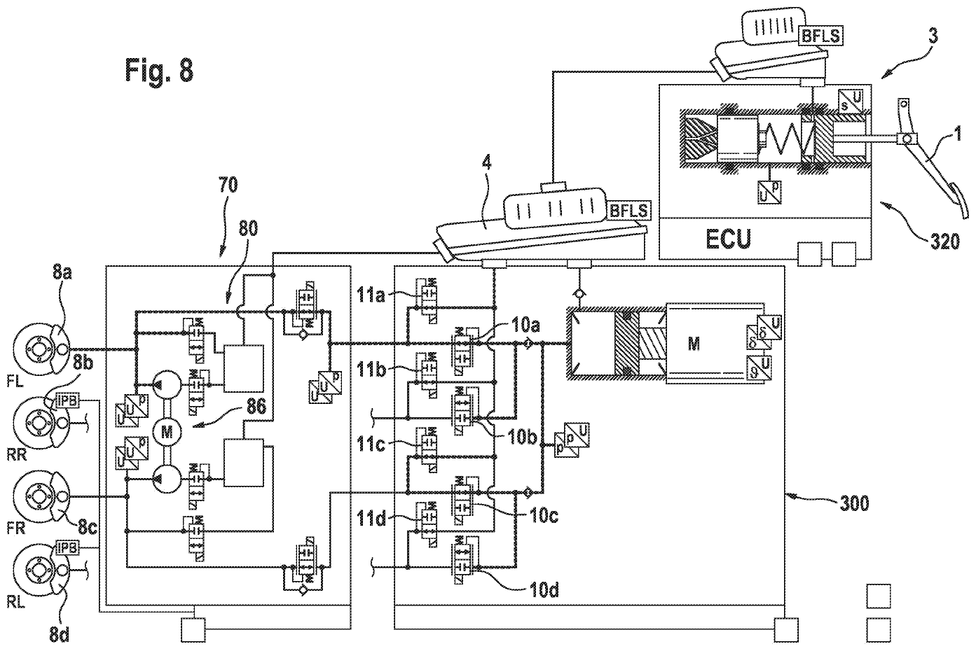

In the state of the braking system 1a during the ESC control process shown in FIG. 8, the inlet valves 10a and 10c are open, while the inlet valves 10b and 10d are closed. The outlet valves 11a and 11c are open, while the outlet valves 11b and 11d are closed. In this way, wheel brake pressure can be reduced in wheel brakes 8a and 8c.

1. A braking system for motor vehicles, for highly automated driving, with at least four, hydraulically actuable wheel brakes and with a primary brake control unit, the braking system comprising:
at least one electrically actuable wheel valve for each wheel brake, the wheel valve configured for setting wheel-specific brake pressures;
a pressure medium storage tank at atmospheric pressure;
an electrically controllable pressure provision device for actuating the wheel brakes with a hydraulic pressure chamber, wherein the respective wheel brake is connected or can be connected hydraulically to the pressure chamber; and
wherein the braking system comprises a simulation unit with a simulator which can be actuated with the aid of a brake pedal, and an auxiliary module, wherein the auxiliary module comprises a hydraulic unit with an electrically controllable, pressure provision device for active pressure build-up in at least two of the wheel brakes, and wherein the simulation unit is designed as a separate module.

2. The braking system as claimed in claim 1, wherein the simulation unit has a hydraulic pressure chamber, which is connected hydraulically to a simulator unit pressure medium storage tank.

3. The braking system as claimed in claim 2, wherein the simulator unit pressure medium storage tank is connected hydraulically to the pressure medium storage tank of the primary brake control unit.

4. The braking system as claimed in claim 2, wherein the simulation unit has a control and regulating unit.

5. The braking system as claimed in claim 2, wherein the simulation unit has a control and regulating unit for driver demand detection.

6. The braking system as claimed in claim 4, wherein a pressure sensor is provided for determining the pressure in the pressure chamber and wherein a travel sensor is provided for determining actuating travel of the brake pedal, and wherein the control and regulating unit of the simulation unit is connected on a signal input side to both sensors.

7. The braking system as claimed in claim 1, wherein the primary brake control unit and the auxiliary module are designed as structurally separate components.

8. The braking system as claimed in claim 7, wherein the primary brake control unit and/or the auxiliary module have/has a fastener for mutual fastening and/or for fastening on the simulation unit.

9. The braking system as claimed in claim 1, wherein no brake master cylinder that can be actuated with the aid of the brake pedal is provided.

10. The braking system as claimed in claim 1, wherein at least one check valve is inserted into a hydraulic connection between the pressure chamber and the wheel brakes, which check valve prevents a return flow of brake fluid from the direction of the wheel brakes into the pressure chamber and allows an inflow of brake fluid from the pressure chamber in the direction of the wheel brakes.

11. The braking system as claimed in claim 1, wherein each wheel brake is assigned an inlet valve, which is open when deenergized.

12. The braking system as claimed in claim 1, wherein each wheel brake is assigned an outlet valve, which is closed when deenergized.

13. The braking system as claimed in claim 1, wherein a pressure sensor is provided for measuring the pressure in the pressure chamber of the pressure provision device.

14. The braking system as claimed in claim 1, wherein at least one reservoir for brake fluid is integrated into the hydraulic unit in the auxiliary module.

15. The braking system as claimed in claim 14, wherein the respective reservoir is connected to a hydraulic equalization line, which is provided for forming a connection to the atmosphere.

16. The braking system as claimed in claim 14, wherein the pressure provision device of the auxiliary module comprises at least one pump, which is driven by an electric motor and a suction side of which is hydraulically connected to the respective reservoir.
